(19) United States
(12) Patent Application Publication
(10) Pub. No.: US 2022/0311783 A1
(43) Pub. Date: Sep. 29, 2022

(54) SYSTEM AND METHOD FOR ADAPTIVE MICRO SEGMENTATION AND ISOLATION OF CONTAINERS

(71) Applicant: Microsec Inc, Fremont, CA (US)

(72) Inventor: Mitthan Lal Meena, Fremont, CA (US)

(21) Appl. No.: 17/214,874

(22) Filed: Mar. 28, 2021

(51) Int. Cl. H04L 29/06; G06N 20/00; H04L 29/08

(52) U.S. Cl. CPC H04L 63/1416; G06N 20/00; H04L 67/32; H04L 63/20

(57) ABSTRACT

Disclosed herein is a system and a computer implemented method for adaptive micro segmentation and isolation of compromised containers inn networked environment. The system and methods disclosed herein provides a machine learning and artificial intelligence based micro-segmentation for isolation of containers during runtime responsive to a compromise. The system is adaptive to the runtime container security profile and isolates compromised containers based on real time data. A processing unit is configured to identify one or more compromised containers amongst a plurality of containers that are part of a microservices architecture working in a networked environment. The processor identifies the one or more compromised containers and isolates the said one or more compromised containers in order to contain the spread of security attack on to remaining containers, while diverting the traffic to similar containers running similar applications, thereby maintaining integrity of services in real time. The processor is further operable to identify one or more risky containers in addition to compromised containers and create an ethical wall surrounding the containers running core and essential services so that said services are not disrupted.

### TECHNICAL FIELD

This disclosure relates to generally to computer system and processes for cyber security, and, more particularly, to runtime security management of containers used in microservices architecture.

### BACKGROUND

Microservices are one of latest and popular architectural design implementations in the software development industry wherein multiple services are designed in form of smaller service units loosely coupled to one another as against the basic monolithic architecture. Microservices are easier to develop, test, deploy and maintain. While they are extremely popular choices for software development, they suffer from security issues due to multiple entry points. While in a monolithic architecture, a single security policy could be effective, microservices applications are several in number, each requiring a separate and unique security policy. Moreover, microservices can be difficult to develop from a security standpoint. Often microservices developers grant unneeded permissions to microservices, giving the microservices more system access than necessary. These unneeded permissions make it easier for hackers to compromise a microservices host if an individual microservices has been compromised.

Conventionally, static security policies have been used to prevent microservices containers from being compromised. These security policies inherently include use of firewalls and static identifiers, host IP data etc. Optionally, security systems are known in the prior art that identify and remediate security attacks once the services have been affected.

Traditional techniques, such as the use of static security policies are difficult to apply to microservices architectures, especially for applications comprising thousands of distinct microservices. Further, because microservices are frequently deployed, modified, re-deployed, and lack static identifiers such as hostnames or IP addresses, it can be difficult to identify a microservices that has been attacked by a hacker. However, traditional security systems merely detect and malwares/ransomwares and recommend remedial measures. Further, traditional systems require the services to be shut down completely in order to undertake remedial measures, thereby resulting in disruption of services to end consumer. Moreover, the conventional systems do not provide a means to contain the spread of attack on the network.

In light of above mentioned problems, there does not exist a solution that provides a real-time security management for microservices containers and it is desirable to have a system and process that provides runtime container security through run-time micro segmentation and isolation of comprised containers

### SUMMARY

The present disclosure seeks to provide a system and a computer implemented method for adaptive micro segmentation and isolation of compromised containers inn networked environment. A processing unit is configured to identify one or more compromised containers amongst a plurality of containers that are part of a microservices architecture working in a networked environment. The processor identifies the one or more compromised containers and isolates the said one or more compromised containers in order to contain the spread of security attack on to remaining containers, while diverting the traffic to similar containers running similar applications, thereby maintaining integrity of services in real time. The processor is further operable to identify one or more risky containers in addition to compromised containers and create an ethical wall surrounding the containers running core and essential services so that said services are not disrupted. The system further provides for taking snapshots of the one or more comprised containers for digital forensics.

Embodiments of the present disclosure substantially eliminate or at least partially address the aforementioned problems.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 depicts the block diagram of the exemplary system as per the present disclosure.

FIG. 2 depicts the discovery server entries as per one of the embodiments of the present disclosure.

FIG. 3 depicts the network logic graph as per the present disclosure.

FIG. 4 depicts a network logic graph with an ethical wall.

FIG. 5 is a flow chart depicting the method steps of the present invention.

It will be appreciated that the drawings illustrated herein are for representation purposes only and do not intend to limit the scope of the present disclosure, and actual implementation of the present disclosure may be viewed substantially differently.

### DETAILED DESCRIPTION

The following description illustrates embodiments of the present disclosure and ways in which they can be implemented. Although some modes of carrying out the present disclosure have been disclosed, those skilled in the art would recognize that other embodiments for carrying out or practicing the present disclosure are also possible.

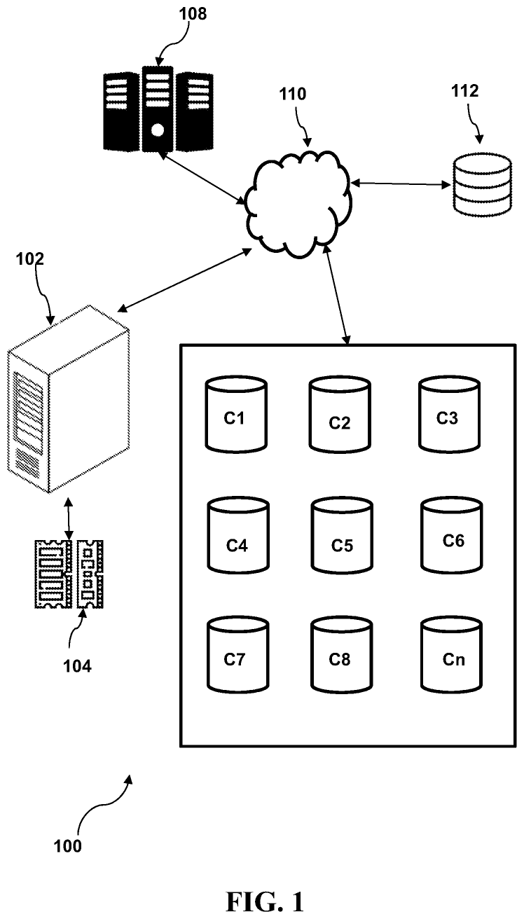

Referring to FIG. 1, the system comprises a processor 102 with a memory 104 comprising executable non-transitory machine readable instructions wherein the processor 102 is configured to execute the said machine readable instructions, and wherein the processor 102 is communicably coupled to a server arrangement via a data communication network 110. The processor 102 is configured to identify one or more compromised containers from a plurality of containers on a networked environment 106 though the server arrangement 108. The system further comprises a discovery database 112 communicably coupled to the processor 102.

Throughout this disclosure, the term “container” means software packages hosting microservices through Docker/Kubernetes platform and may comprises pods. A container is a standard unit of software that packages up code and all its dependencies so the application runs quickly and reliably from one computing environment to another. The containers bundle an application's code together with the related configuration files and libraries, and with the dependencies required for the app to run. Throughout this disclosure, the term container is used interchangeably with “pods”, nodes or resources wherein a pod may run a single container or a group of microservices containers. A “software container” or “container” may include lightweight, standalone executable software packages. Containers typically take up less memory than virtual machines. A software container may include everything needed to run an application or micro-service, including code, system tools, system libraries, and settings. Software containers may be isolated from one another and communicate through well-defined channels. Containers may share operating system resources including the kernel. Further, containers may be created from container images that specify their contents.

“Microservices” may include services that operates in a loosely coupled manner with a collection of other microservices in order to implement an application. For example, a video streaming server may provide a video streaming service to client computers using a plurality of microservices, wherein one micro-service may provide the user interface front end, another microservices may manage a database of videos, a third microservices may manage video encoding, etc. A “micro-service image” may refer to a software container image used to implement a microservices on a host system. The micro-service image may include executable files and their software dependencies, which can be executed in order to implement the microservices.

The term “compromised container” means a container which has been attacked or hacked and has been behaving in a malicious manner thereby presenting a threat to microservices delivery and underlying data. Generally, in case of cyber-attacks, the containers are compromised with a malware that can spread malware to another container, and encryption, if any, will hide the malware transfer as well as legitimate data flows. Such malware can be transferred to a container image through several entry points. An example scenario could be a container image containing application with remote code execution.

Optionally, the term compromised container comprises near-compromised containers that are not directly infested with malware but is highly probable to have been infested through malware spread. The processor 102 is operable to calculate a risk score for each of the containers on the networked environment and designate all containers above a predetermined threshold risk score as near-compromised.

The processor 102 is configured to identify one or more compromised containers in the networked environment. The processor 102 identifies the one or more compromised containers based on analysis of Denial of service attacks, ransomware and malware attacks on the plurality of containers. Further, the processor 102 is operable to identify said one or more compromised containers based on existing security policy as maintained for the networked environment. An example of said security policy could be Pod Security Policies, firewall protocols and antivirus software's. Moreover, the processor 102 identifies one or more compromised containers based on a list of pre-identified and publicly known information security vulnerabilities and exposures. Non-limiting example of said vulnerabilities are container namespace related vulnerabilities.

Optionally, the processor 102 is configured to identify one or more compromised containers in the networked environment by deploying a machine learning model. The machine learning model comprises parameters related to traffic patterns, multiple failed authentication attempts, anomaly detection in relation to file or network permissions, configuration files and analysis of system call logs for each of the plurality of containers. The machine learning model analyses the traffic patterns for each of the plurality of containers on the networked platform and identifies unusual behavior in form of excess traffic or extremely reduced traffic or diverted traffic requests.

Throughout this disclosure, the term “networked environment” refers to an environment where a plurality of containers communicates with one other based on a network control policy. As depicted in FIG. 1, the plurality of containers in the networked environment are labelled as C1, C2, C3 . . . Cn. The networked environment 106 is provided by means of one or more servers forming part of the server arrangement 108 and communicating with one other over the data communication network 110.

A “machine learning model” may include an application of artificial intelligence that provides systems with the ability to automatically learn and improve from experience without explicitly being programmed. A machine learning model may include a set of software routines and parameters that can predict an output of a process (e.g., identification of an attacker of a computer network, authentication of a computer, a suitable recommendation based on a user search query, etc.) based on a “feature vector” or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines, models that classify data by establishing a gap or boundary between inputs of different classifications, as well as neural networks, collections of artificial “neurons” that perform functions by activating in response to inputs.

Optionally, the machine learning model includes a machine learning classifier that designates a container as compromised or non-compromised.

Optionally, the machine learning model may include input from manual security policies for identifying one or more compromised containers.

Responsive to determining one or more compromised containers, the processor 102 is configured to re-assign services rendered through each of the one or more compromised containers to a similar container in the networked environment. The processor 102 is operable to identify one or more similar containers in the networked environment and divert the traffic from each of the one or more compromised containers to the corresponding similar container. The term “similar container” refers to containers capable of rendering services similar to the compromised container and with similar logical application layer.

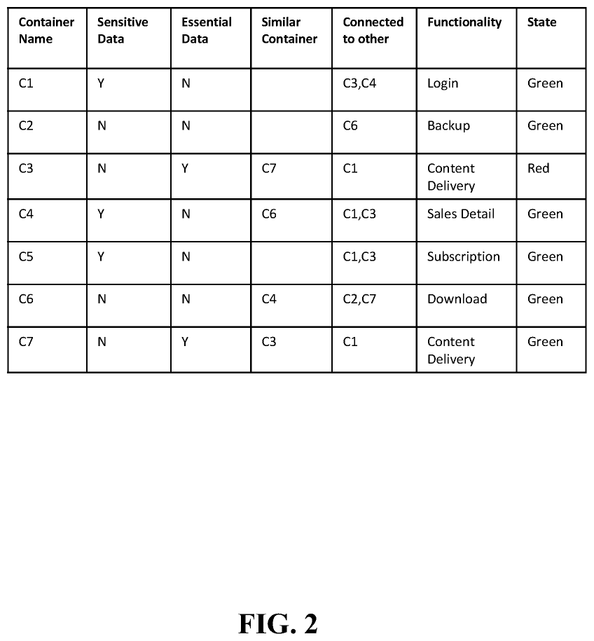

In an embodiment of the present invention, the processor 102 accesses a discovery database 112 that stores information pertaining to container services, configuration data, functionalities rendered, traffic flows to other containers, similar containers in the networked environment with logical similarity at application level, list of assets and resources accessible by the container, and importance level of said assets and resources. FIG. 2 depicts the discovery database entries as per one of the embodiments of the present disclosure. As an example, an entry 202 depicts a content delivery microservices C3 having a similar container rendering identical service and named C7 which means function of C3 can be accessed through C7 as well. The processor 102 can therefore identify the similar container for C3 as C7 for re-assigning the service delivery from the compromised container C3 to C7. The discovery database further compromises a log of previous version of container images. The discovery database is pre-populated and kept updated as per changes in the networked environment. This functionality results in dynamic runtime micro-segmentation of container services in a networked environment.

In yet another embodiment, the processor 102 is configured to label one or more compromised containers as quarantined or rouge and thereby enabling namespace isolation.

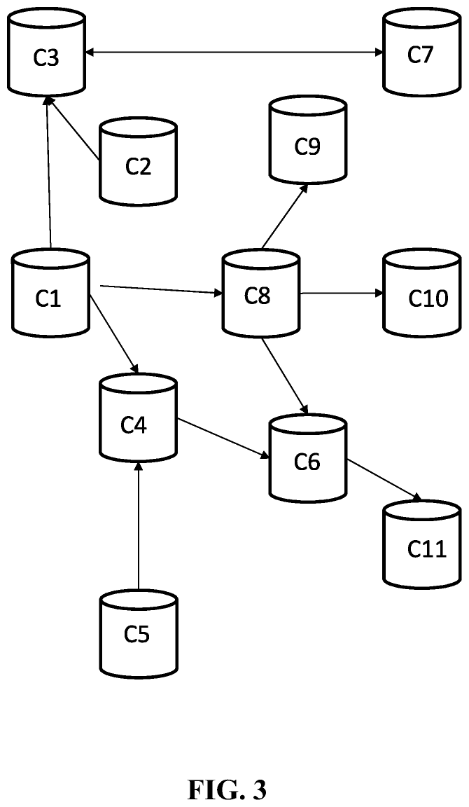

In an aspect of the present invention, the processor 102 generates a network logic graph for the plurality of containers in the networked environment. FIG. 3 depicts the network logic graph 300 as per the present disclosure. The network logic graph 300 is generated based on the data from the discovery database. The network logic graph 300 comprises edges which denote flow of traffic and dependencies between the plurality of containers in the networked environment. The network logic graph further provides a logic view of all services running through their respective microservices containers. Optionally, the network logic graph 300 is used by the processor 102 to recommend similar containers by identifying alternate paths for the purpose of reassigning services from the compromised container. The network logic graph is rendered on a client device with a graphical user interface and communicably coupled to the server arrangement.

In yet another embodiment of the present invention, the processor 102 is operable to recommend a similar container, to a user, on the network logic graph, thereby enabling the user to manually select a similar container for diverting traffic from one of the compromised containers. The compromised containers with quarantined label are visually marked up on the network logic graph to give a clear picture of the state of the networked environment and probable alternate traffic flow paths between containers. Further, the risk score of each of the plurality of containers is visually depicted on the network graph. Optionally, the processor 102 assigns a color code for each of the plurality of container based on the risk score. As an example, red color coded containers depict the compromised containers whereas the orange color containers represent the near-compromised containers and green color depicting healthy containers. The network logic graph provides a means of manual runtime micro-segmentation of container services.

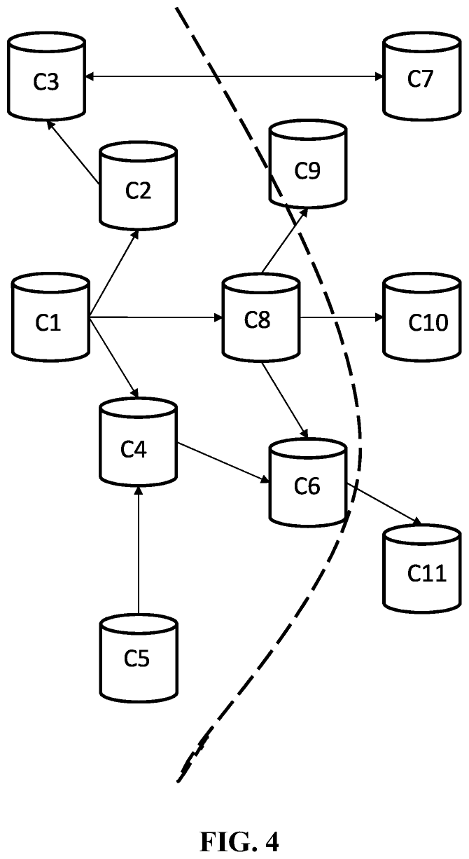

In yet another embodiment of the present invention, the processor 102 is operable to demarcate an ethical wall encompassing healthy containers wherein the ethical wall represents a logical boundary between the healthy containers and the risky containers comprising compromised and near-compromised containers. FIG. 4 depicts a network logic graph with an ethical wall. Alternatively, the ethical wall surrounds the containers rendering essential services and sensitive data.

Optionally, the processor 102 is enabled to send a request to a container orchestration platform to span a new container in case a similar container for one of the one or more compromised containers is not identified, and divert all incoming service traffic from the compromised container to the new container. Optionally, the processor 102 is operable to deploy one or more new containers, for each of the corresponding one or more compromised containers, on to the network wherein the each of the one or more new containers comprises a safe image of the software application running via the corresponding container from the one or more compromised containers. This maintains the integrity of microservices delivery and the end customer throughout is not affected on account of malicious attacks and barring the need of bringing down entire service network.

In an embodiment of the present invention, the processor 102 is configured to take a snapshot of each of the one or more compromised containers for forensic analysis. The snapshot of container includes acquisition of data related to file layers, traffic patterns, common vulnerabilities and exposures on the compromised container and its configuration. Preferably, snapshotting of the compromised container is done with the compromised container in freeze state. Optionally, snapshot of the disk of a node that was running the said compromised container is also captured by the processor 102.

Optionally, a snapshot data from each of the one or more compromised container is used for digital forensics. Beneficially, the snapshot is converted into a compatible format for further processing and digital forensic analysis. Optionally, the processor 102 is operable to store container snapshots on an ancillary server.

Digital forensics is conducted to investigate root causes of the container compromise. Optionally, digital forensic is carried out based on cloud infrastructure logs, Audit logs, Application logs, Operating system logs such as network connections, User logins, SSH sessions, and execution logs.

Subsequent to diverting the traffic on the compromised container to a similar container on the networked environment, the processor 102 is configured to isolate each of the one or more compromised containers from the remaining plurality of containers on the networked environment. As per the preferred embodiment of the present invention, isolating the containers comprises bringing down communications to the compromised container. Bringing down communications comprises suspending container execution, including interrupting any malware currently executing, and restricting data flow to and from the compromised containers and the remaining of the containers and associated servers and one or more client devices and dynamically altering Network control policy that manages communication on specific ports and in specific directions. In an embodiment, the network control policies enable each project with its own virtual network ID, thereby isolating project networks from each other on the node. Optionally, the isolation is hardware isolation of compromised containers by dropping incoming packets via a hardware-based method. Optionally, the processor 102 provides isolation of the compromised container by intercepting application system calls to each of the one or more compromised containers and acting as the guest kernel in the user-space. In another embodiment, the one or more compromised containers can be isolated by restricting kernel-level resources.

Optionally, in case the number of compromised containers crosses a threshold mark, the processor 102 is operable to shut down the networked environment.

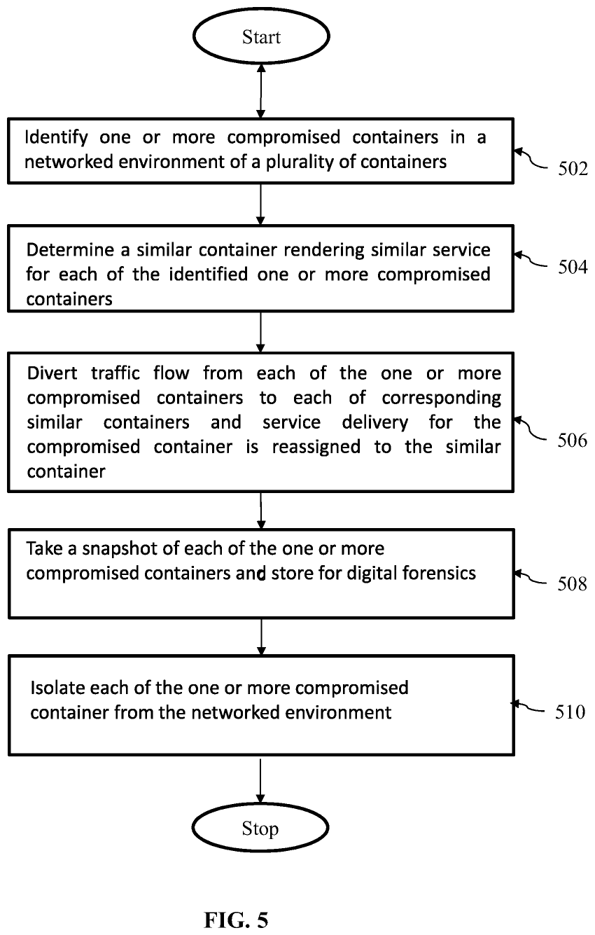

Referring to FIG. 5, method steps disclosed by the present invention comprises identifying one or more compromised containers in a networked environment of a plurality of containers at step 502. At step 504, a similar container rendering similar service for each of the identified one or more compromised containers is determined. At step 506, traffic flow from each of the one or more compromised containers is diverted to each of corresponding similar containers and service delivery for the compromised container is reassigned to the similar container. At step 508, a snapshot of each of the one or more compromised containers is taken and stored for digital forensics. At step 510, each of the one or more compromised container is isolated from the networked environment.

It shall be appreciated by person skilled in the art that the system and method disclosed herein provides machine learning and artificial intelligence based micro-segmentation for isolation of containers during runtime responsive to a compromise. The system is adaptive to the runtime container security profile and isolates compromised containers based on real time data.

Client devices may comprise any type of computing device, such as a desktop computer system, a laptop, cellular phone, a smart device, a mobile telephone, a tablet style computer, or any other device capable of wireless or wired communication. In some implementations, client devices are configured to interact with the processor 102 via an application, such as a web browser or a native application, residing on the client device.

The data communication network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of the foregoing.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface.

In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor 102 in a modular or integrated manner. As used herein a processor 102 includes a single-core processor, multi-core processor 102 on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Moreover, it will be appreciated that the server arrangement can be implemented by way of a single hardware server. The server arrangement can alternatively be implemented by way of a plurality of hardware servers operating in a parallel or distributed architecture. As an example, the server arrangement may include components such as a memory unit, a processor, a network adapter, and the like, to store and process information pertaining to the document and to communicate the processed information to other computing components, for example, such as a client device. Furthermore, the server arrangement comprises a database arrangement for storing data therein.

Any of the software components or functions described in this application may be implemented as software code to be executed by a processor 102 using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can be involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may be involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary. The use of “or” is intended to mean an “inclusive or,” and not an “exclusive or” unless specifically indicated to the contrary.

1. A method of adaptive micro segmentation and isolation of containers in a networked environment, the method comprising a processor configured for:
identifying one or more compromised container from a plurality of containers in the networked environment;
re-assigning services rendered through the one or more compromised containers to respective one or more similar containers in the networked environment; and
isolating the one or more comprised containers from the remaining plurality of containers.

2. The method of claim 1 wherein the one or more compromised container is identified by a machine learning model comprising parameters related to traffic pattern, configuration files and system call logs of each of the one or more comprised containers.

3. The method of claim 1 wherein the processor is configured to snapshot each of the one or more compromised containers for digital forensics.

4. The method of claim 1 wherein each of the one or more compromised containers is isolated by bringing down communications to the said compromised container in the networked environment.

5. The method of claim 1 wherein the processor is further operable to deploy one or more new containers, for each of the corresponding one or more compromised containers, on to the network wherein the each of the one or more new containers comprises a safe image of the software application running via the corresponding container from the one or more compromised containers.

6. The method of claim 1 wherein the processor is operable to identify the one or more similar containers in the networked environment wherein the similar container renders a similar software application and divert the traffic from each of the one or more compromised containers to the corresponding similar container.

7. The method of claim 1 wherein the processor is enabled to send a request to a container orchestration platform to span a new container in case a similar container for one of the one or more compromised containers is not identified.

8. The method of claim 1 wherein the processor is configured to deploy a similar container on to the networked environment prior to isolating the corresponding compromised container.

9. The method of claim 1 wherein the processor is further configured to identify an ethical wall for the networked environment based on a risk score for each of the plurality of containers on the networked environment.

10. The method of claim 1 wherein the processor is further enabled to dynamically alter a network control policy of the plurality of containers in the networked environment in response to detection of one or more compromised containers.

11. A system for adaptive micro segmentation and isolation of containers in a networked environment, the system comprising:
a server arrangement hosting a plurality of containers in the networked environment;
a processor communicably coupled, via a data communication network, to the server arrangement wherein the processor is configured to:
identify at least one compromised container from a plurality of containers in the networked environment;
re-assign services rendered through the compromised container to at least one other container in the networked environment; and
isolate the comprised container from the remaining plurality of containers;
a discovery database coupled to the processor and the server arrangement.

12. The system of claim 11 wherein the one or more compromised container is identified by a machine learning model comprising parameters related to traffic pattern, configuration files and system call logs of each of the one or more comprised containers.

13. The system of claim 11 wherein the processor is configured to snapshot each of the one or more compromised containers for digital forensics.

14. The system of claim 11 wherein each of the one or more compromised containers is isolated by bringing down communications to the said compromised container in the networked environment.

15. The system of claim 11 wherein the processor is further operable to deploy one or more new containers, for each of the corresponding one or more compromised containers, on to the network wherein the each of the one or more new containers comprises a safe image of the software application running via the corresponding container from the one or more compromised containers.

16. The system of claim 11 wherein the processor is operable to identify the one or more similar containers in the networked environment wherein the similar container renders a similar software application and divert the traffic from each of the one or more compromised containers to the corresponding similar container.

17. The system of claim 11 wherein the processor is enabled to send a request to a container orchestration platform to span a new container in case a similar container for one of the one or more compromised containers is not identified.

18. The system of claim 11 wherein the processor is configured to deploy a similar container on to the networked environment prior to isolating the corresponding compromised container.

19. The system of claim 11 wherein the processor is further configured to identify an ethical wall for the networked environment based on a risk score for each of the plurality of containers on the networked environment.

20. The system of claim 11 wherein the processor is further enabled to dynamically alter a network control policy of the plurality of containers in the networked environment in response to detection of one or more compromised containers.
